(19) United States
(12) Patent Application Publication
(10) Pub. No.: US 2017/0061933 A1
(43) Pub. Date: Mar. 2, 2017

(54) Display Panel with Slim Border and Method of Driving Display Panel

(71) Applicant: AU Optronics Corp., Hsin-Chu (TW)

(72) Inventors: Shuo-Wen Jang, Hsin-Chu (TW); Jui-Chi Lo, Hsin-Chu (TW)

(21) Appl. No.: 15/232,790

(22) Filed: Aug. 9, 2016

(30) Foreign Application Priority Data
Aug. 28, 2015 (CN) 201510539638.7

(51) Int. Cl. G09G 5/18

(52) U.S. Cl. CPC G09G 5/18; G09G 2300/0439; G09G 2310/08

(57) ABSTRACT

A display panel includes a pixel block, a data circuit, and a data source. The pixel block includes a first sub-pixel coupled to a first data line, and N second sub-pixels. Each second sub-pixel of the N second sub-pixels is coupled to a corresponding second data line of N second data lines. The data circuit includes N switches. Each switch of the N switches is coupled to a corresponding second sub-pixel. When N voltage levels are sequentially outputted from the data source to the first data line and the N second data lines, the N switches are disabled sequentially.

### BACKGROUND OF THE INVENTION

1. Field of the Invention

The present invention generally illustrates a display panel, and more particularly, a display panel with slim border.

2. Description of the Prior Art

With the advancement of techniques, various monitors and display panels are adopted in our daily life. The display panel can be applied to a smart phone, a tablet, a laptop computer, or a personal computer. Specifically, the display panel embedded on the device is required to satisfy requirements of being slim, light, low power consumption, and high display quality. Since the display panel with a maximum pixel capacity can perform satisfactory display quality, display developers and manufacturers make effort to improve pixel density of display panel in conjunction with a slim border for increasing display quality and market competitiveness.

Conventionally, several non-rectangular shaped display panels are also applied to electronic devices. For example, a display panel of a smart watch (i.e., an Apple® i-watch) and some measurement panels of sensors are manufactured with arc-shaped or rounded corners. In general, the display panel includes a data source for generating data signal. The data signal is transmitted to each pixel block of the display through a fan-out circuit. Particularly, in a non-rectangular shaped display panel, data circuits are respectively coupled to corresponding pixel blocks according to predetermined allocations.

Although conventional display panels use different allocation methods for reducing the layout area requirement of the display panel, additional layout area of display panel are still required. Thus, the width of border cannot be optimized.

### SUMMARY OF THE INVENTION

In an embodiment of the present invention, the display panel is disclosed. The display panel includes a pixel block, a data circuit, and a data source. The pixel block includes a first sub-pixel coupled to a first data line, and N second sub-pixels. Each second sub-pixel of the N second sub-pixels is coupled to a corresponding second data line of N second data lines. The data circuit includes N switches. Each switch of the N switches is coupled to a corresponding second sub-pixel. The data source is coupled to the first data line and the N second data lines. When N voltage levels are sequentially outputted from the data source to the first data line and the N second data lines, the N switches are disabled sequentially so that when a corresponding voltage level is written to the first sub-pixel, the corresponding voltage level is written to at least one second sub-pixel of the N second sub-pixels, and N is a positive integer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a structure of a display panel according to a first embodiment of the present invention.

FIG. 2 illustrates allocations of fan-out circuits of the display panel in FIG. 1.

FIG. 3 illustrates a driving method of the display panel in FIG. 2 by using gate circuits.

FIG. 4 illustrates a circuit structure of pixel blocks and data circuits of the display panel in FIG. 1.

FIG. 5 illustrates a structure of a display panel according to a second embodiment of the present invention.

### DETAILED DESCRIPTION

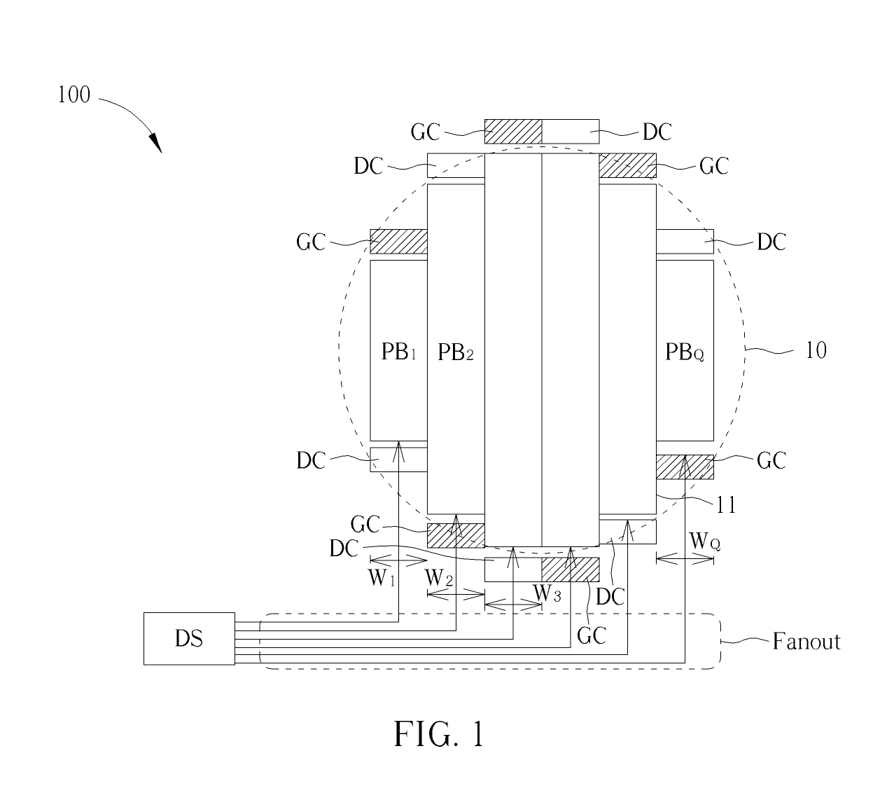

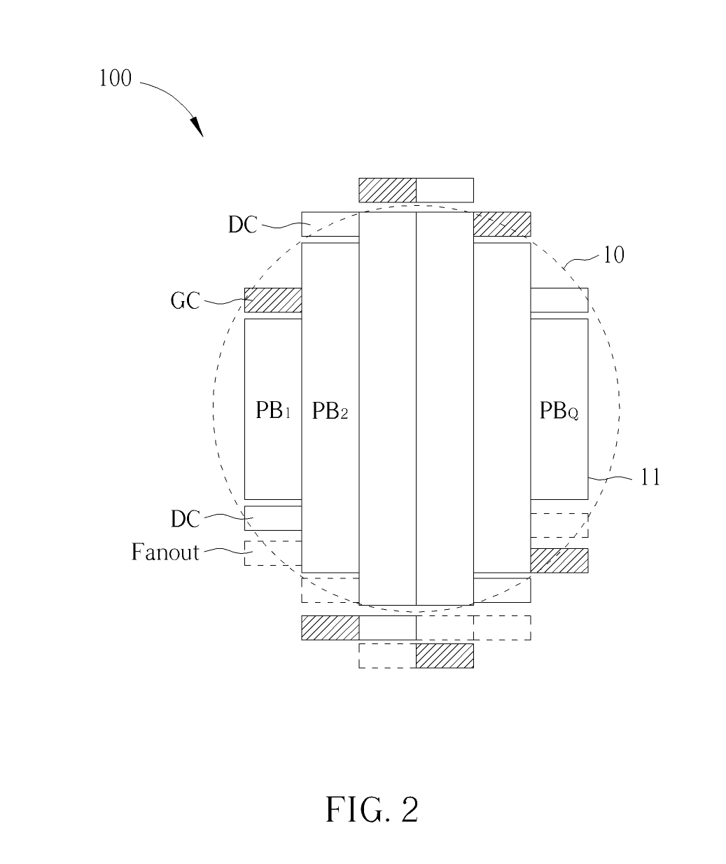

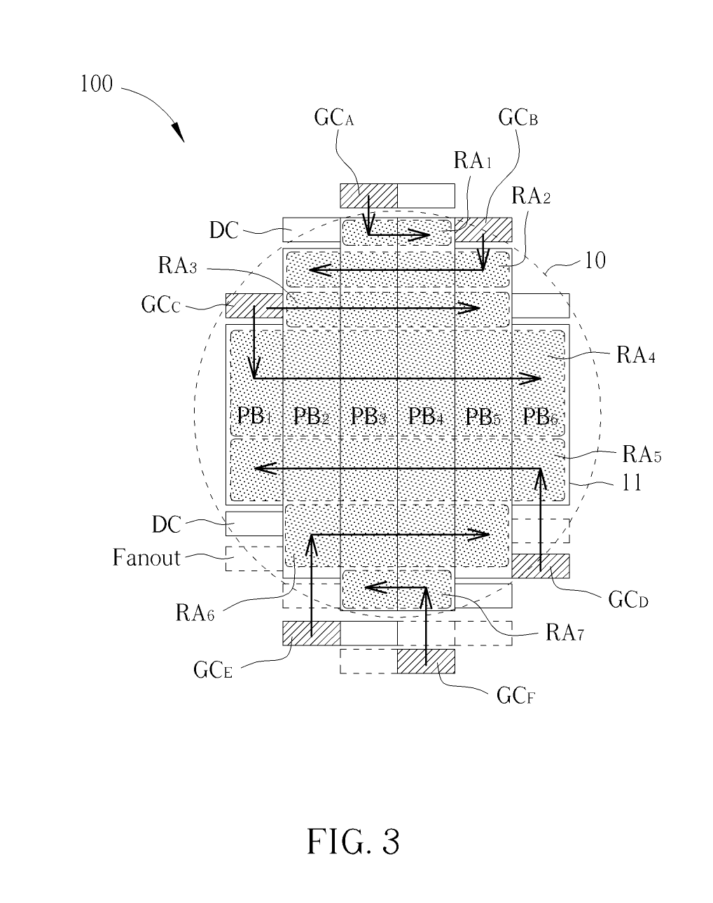

FIG. 1 illustrates a structure of a display panel 100 according to a first embodiment of the present invention. As shown in FIG. 1, the display panel 100 is a circular display panel. The display panel 100 includes a circular display area 10. The display area 10 includes a plurality of rectangular shaped pixel blocks PB₁ to PB_{Q}. Q is a positive integer. The plurality of pixel blocks PB₁ to PB_{Q} forms a pixel region 11. The pixel blocks PB₁ to PB_{Q} include a plurality of sub-pixels. The display panel 100 further includes a plurality of data circuits DC. These data circuits DC are respectively coupled to the pixel blocks PB₁ to PB_{Q} and disposed to the upside and downside of pixel blocks PB₁ to PB_{Q} alternately. As illustrated in FIG. 1, the pixel block PB₁ is coupled to a corresponding data circuit DC. The corresponding data circuit DC is disposed to the downside of the pixel block PB₁. The pixel block PB₂ is coupled to a corresponding data circuit DC. The corresponding data circuit DC is disposed to the upside of the pixel block PB₂, and so on. The display panel 100 further includes a plurality of gate circuits GC. These gate circuits GC are disposed to the upside and downside of the pixel blocks PB₁ to PB_{Q} alternately. As illustrated in FIG. 1, the pixel block PB₁ has a corresponding gate circuit GC disposed to the upside. The pixel block PB₂ has a corresponding gate circuit GC disposed to the downside, and so on. A method for driving the pixel blocks PB₁ to PB_{Q} by using the gate circuits GC is illustrated later (i.e., illustrated in FIG. 3). In other words, in the display panel 100, the gate circuit GC and the data circuit are disposed to two opposite sides of each pixel block PB₁ to PB_{Q}. In the embodiment, the display panel 100 further includes a data source DS and a fan-out circuit (labeled “Fanout”). Specifically, the data source DS can be any device having capability of generating image data or receiving image data. The data source DS can generate an appropriate data signals supported by the display panel 100. The data signals can be transmitted to each pixel block PB₁ to PB_{Q} through the fan-out circuit. The layout of the fan-out circuit of the display panel 100 is not limited to the layout shown in FIG. 1. For example, the fan-out circuit can be allocated according to a structure in FIG. 2. Here, when the data circuits DC receive the data signals generated by the data source DS, sub-pixels of pixel blocks PB₁ to PB_{Q} are driven for displaying image. In the display panel 100, W₁ denotes a width of a data circuit DC corresponding to the pixel block PB₁. W₂ denotes a width of a data circuit DC corresponding to the pixel block PB₂. And so on, W_{Q} denotes a width of a data circuit DC corresponding to the pixel block PB_{Q}. Particularly, W₁ to W_{Q} can be identical values. W₁ to W_{Q} can also be different or partially identical values. Particularly, when Q becomes large, W₁ to W_{Q} can be chosen as small values for increasing the sub-pixel density (or say, capacity) of the pixel blocks PB₁ to PB_{Q} in the display region 10. By doing so, a shape of the pixel region 11 formed by the pixel blocks PB₁ to PB_{Q} is consistent with a shape of display region 10. The method for driving sub-pixels of the pixel blocks PB₁ to PB_{Q} by using the data signals generated by the data source DS through the data circuits DC is illustrated below.

FIG. 2 illustrates allocations of fan-out circuits of the display panel 100. In FIG. 2, the fan-out circuits (i.e., dotted line with labeled ‘Fanout’) can be disposed to a side (downside) of the pixel blocks PB₁ to PB_{Q}. For the pixel blocks PB₁, a corresponding gate circuit GC is disposed to the upside of the pixel blocks PB₁. A corresponding data circuit DC is disposed to the downside of the pixel blocks PB₁. A corresponding fan-out circuit can be disposed to the downside of the corresponding data circuit DC. For the pixel blocks PB₂, a corresponding data circuit DC is disposed to the upside of the pixel blocks PB₂. A corresponding fan-out circuit can be disposed to the downside of the pixel blocks PB₂. A corresponding gate circuit GC can be disposed to the downside of the corresponding fan-out circuit. However, allocations of the fan-out circuits of the display panel 100 are not limited to the allocations illustrated in FIG. 2. In other embodiments, each fan-out circuit can be appropriately disposed to another place for reducing layout area required.

FIG. 3 illustrates a driving method of the display panel 100. In FIG. 3, the pixel blocks PB₁ to PB_{Q} are driven by the gate circuits GC. For simplicity, Q=6 is taken as an example. Here, the pixel blocks of the display panel 100 are labeled as the pixel block PB₁ to the pixel block PB₆. The gate circuits GC of the display panel 100 are labeled as a gate circuit GC_{A}, a gate circuit GC_{B}, a gate circuit GC_{C}, agate circuit GC_{B}, agate circuit GC_{E}, and a gate circuit GC_{F}. Further, dotted areas RA₁ to RA₆ denote as a region (area) of sub-pixels of the display panel 100 (i.e., hereafter ‘sub-pixel region RA₁ to sub-pixel region RA₆’). As shown in FIG. 3, the gate circuit GC_{A} generates driving currents. The driving currents are transmitted to the sub-pixel region RA₁ along a direction of the arrow. Then, the sub-pixel region RA₁ can be driven by the driving currents. Specifically, the sub-pixel region RA₁ includes partial sub-pixels of the pixel block PB₃ and the pixel block PB₄. The gate circuit GC_{B} generates driving currents. The driving currents are transmitted to the sub-pixel region RA₂ along a direction of the arrow. Then, the sub-pixel region RA₂ can be driven by the driving currents. Specifically, the sub-pixel region RA₂ includes partial sub-pixels of the pixel block PB₂ to the pixel block PB₅. The gate circuit GC_{C} generates driving currents. The driving currents are transmitted to the sub-pixel region RA₃ along a direction of the arrow. Then, the sub-pixel region RA₃ can be driven by the driving currents. Specifically, the sub-pixel region RA3 includes partial sub-pixels of the pixel block PB2 to the pixel block PB5. The gate circuit GC_{C} also generates another driving currents. The driving currents are transmitted to the sub-pixel region RA₄ along another direction of the arrow. Then, the sub-pixel region RA₄ can be driven by the driving currents. Specifically, the sub-pixel region RA₄ includes partial sub-pixels of the pixel block PB₁ to the pixel block PB₆. The gate circuit GC_{D} generates driving currents. The driving currents are transmitted to the sub-pixel region RA₅ along a direction of the arrow. Then, the sub-pixel region RA₅ can be driven by the driving currents. Specifically, the sub-pixel region RA₅ includes partial sub-pixels of the pixel block PB₁ to the pixel block PB₆. The gate circuit GC_{E} generates driving currents. The driving currents are transmitted to the sub-pixel region RA₆ along a direction of the arrow. Then, the sub-pixel region RA₆ can be driven by the driving currents. Specifically, the sub-pixel region RA₆ includes partial sub-pixels of the pixel block PB₂ to the pixel block PB₅. The gate circuit GC_{E} generates driving currents. The driving currents are transmitted to the sub-pixel region RA₇ along a direction of the arrow. Then, the sub-pixel region RA₇ can be driven by the driving currents. Specifically, the sub-pixel region RA₇ includes partial sub-pixels of the pixel block PB₃ and the pixel block PB₄. By doing so, all sub-pixels of the display panel 100 can be driven by using the gate circuit GC_{A}, the gate circuit GC_{B}, the gate circuit GC_{C}, the gate circuit GC_{D}, the gate circuit GC_{E}, and the gate circuit GC_{F} in sequential. However, the driving method of the present invention is not limited to the driving method in FIG. 3. The direction of driving currents with respect to the gate circuit GC_{A} to the gate circuit GC_{F} in FIG. 3 can be also modified. For example, the driving currents of gate circuit GC_{F} can be transmitted along an opposite direction in FIG. 3. Further, the gate circuit GC_{A} to the gate circuit GC_{F} can drive specific sub-pixel regions. For example, the gate circuit GC_{F} can also drive the sub-pixel region RA₆. In other words, a single gate circuit can drive a plurality of sub-pixel regions. For a single sub-pixel region, driving currents can be inputted from a plurality of gate circuits. For example, the sub-pixel region RA₄ can be driven by using driving currents generated by the gate circuit GC_{D} and the gate circuit GC_{C}.

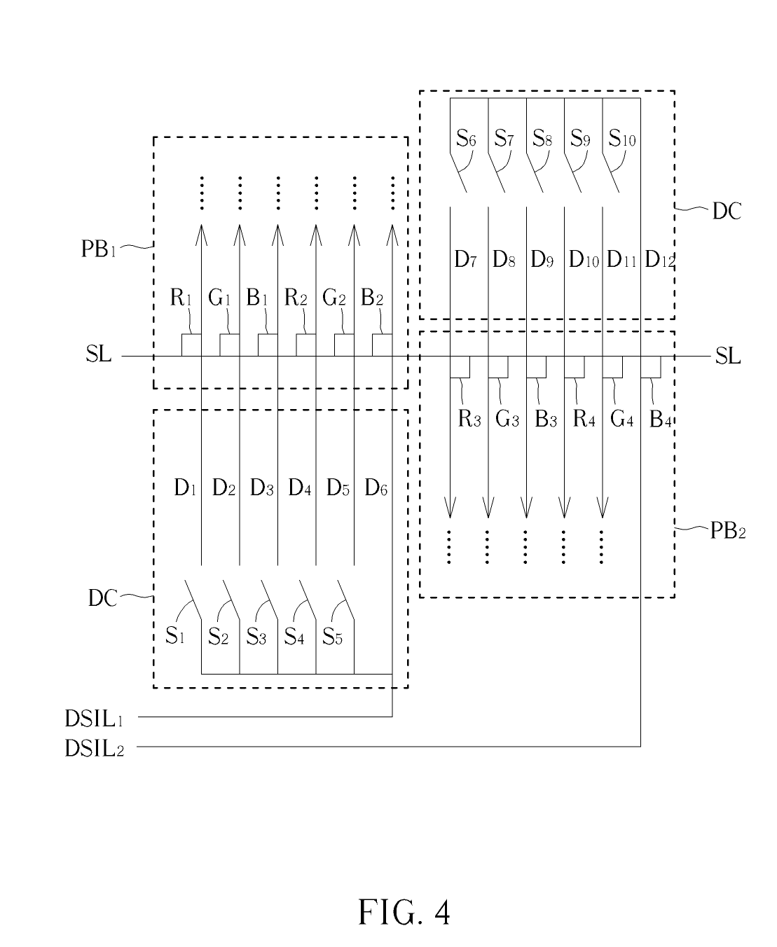

FIG. 4 illustrates a circuit structure of pixel blocks PB₁ and PB₂ and the corresponding data circuits DC of the display panel 100. As shown in FIG. 4, the pixel blocks PB₁ includes a sub-pixel R₁, a sub-pixel G₁, a sub-pixel B₁, a sub-pixel R₂, a sub-pixel G₂, a sub-pixel B₂, and a scan line SL. These sub-pixels are respectively coupled to data lines D₁ to D₆. The pixel blocks PB₂ of the display panel 100 includes a sub-pixel R₃, a sub-pixel G₃, a sub-pixel B₃, a sub-pixel R₄, a sub-pixel G₄, a sub-pixel B₄, and a scan line SL. These sub-pixels are respectively coupled to data lines D₇ to D₁₂. In the display panel 100, a structure of pair-wised pixel blocks is similar to a structure of the pixel blocks PB₁ and PB₂. Further, the sub-pixels are allocated sequentially according to a pixel sequence formed by a red sub-pixel, a green sub-pixel, and a blue sub-pixel. For presentation brevity, two pixel blocks PB₁ and PB₂ are considered. Here, a data circuit DC disposed to the downside of the pixel block PB₁ can be a demultiplexer. The dimension of the demultiplexer in the embodiment is equal to six. The data circuit DC of the pixel block PB₁ includes a switch S₁, a switch S₂, a switch S₃, a switch S₄, and a switch S₅. The data circuit DC of the pixel block PB₂ includes a switch S₆, a switch S₇, a switch S₈, a switch S₉, and a switch S₁₀. A data source line DSL₁ is coupled to the data line D₆, wherein the data source line DSL₁ is also coupled to a data source DS (shown in FIG. 1). The data line D₁ to the data line D₅ of the pixel block PB₁ are respectively coupled to the data line D₆ through the switch S₁ to the switch S₅. Similarly, a data source line DSL₂ is coupled to the data line D₁₂, wherein the data source line DSL₂ is also coupled to a data source DS (shown in FIG. 1). The data line D₇ to the data line D₁₁ of the pixel block PB₂ are respectively coupled to the data line D₁₂ through the switch S₆ to the switch S₁₀. The method for driving sub-pixels (i.e., a row of sub-pixels) of the display panel 100 is illustrated below.

Here, an example is introduced to illustrate a process for driving the sub-pixel R₁, the sub-pixel G₁, the sub-pixel B₁, the sub-pixel R₂, the sub-pixel G₂, and the sub-pixel B₂ of the pixel block PB₁. Similarly, the sub-pixel R₃, the sub-pixel G₃, the sub-pixel B₃, the sub-pixel R₄, the sub-pixel G₄, and the sub-pixel B₄ of the pixel block PB₂ can be driven accordingly. The example is illustrated below. For the pixel block PB₁, a target voltage level of the sub-pixel R₁ is V_{R1}. A target voltage level of the sub-pixel G₁ is V_{G1}. A target voltage level of the sub-pixel B₁ is V_{B1}. A target voltage level of the sub-pixel R₂ is V_{R2}. A target voltage level of the sub-pixel G₂ is V_{G2}. A target voltage level of the sub-pixel B₂ is V_{B2}. First, the scan line SL is activated to enable the sub-pixel R₁ to the sub-pixel B₂. The switch S₁ to the switch S₅ of the data circuit DC corresponding to the pixel block PB₁ are disabled initially. Then, the data source DS generates the voltage level V_{R1}. The voltage level V_{R1} is transmitted to the data line D₆ through the data source line DSL₁ during a first time interval T₁. In the moment, the switch S₁ is enabled. Thus, the voltage level V_{R1} received by the data line D₆ can be also transmitted to the data line D₁. As a result, the sub-pixel B₂ and the sub-pixel R₁ can be respectively charged to reach the voltage level V_{R1} through the data line D₆ and the data line D₁ during the first time interval T₁. After the first time interval T₁ is expired, the switch S₁ is disabled. In the following, the data source DS generates the voltage level V_{G1}. The voltage level V_{G1} is transmitted to the data line D₆ through the data source line DSL₁ during a second time interval T₂. At the time, the switch S₂ is enabled. Thus, the voltage level V_{G1} received by the data line D₆ can be also transmitted to the data line D₂. As a result, the sub-pixel B₂ and the sub-pixel G₁ can be respectively charged to reach the voltage level V_{G1} through the data line D₆ and the data line D₂ during the second time interval T₂. After the second time interval T₂ is expired, the switch S₂ is disabled. In the following, the data source DS generates the voltage level V_{B1}. The voltage level V_{B1} is transmitted to the data line D₆ through the data source line DSL₁ during a third time interval T₃. At the time, the switch S₃ is enabled. Thus, the voltage level B_{B1} received by the data line D₆ can be also transmitted to the data line D₃. As a result, the sub-pixel B₂ and the sub-pixel B₁ can be respectively charged to reach the voltage level V_{B1} through the data line D₆ and the data line D₃ during the third time interval T₃. After the third time interval T₃ is expired, the switch S₃ is disabled. In the following, the data source DS generates the voltage level V_{R2}. The voltage level V_{R2} is transmitted to the data line D₅ through the data source line DSL₁ during a fourth time interval T₄. At the time, the switch S₄ is enabled. Thus, the voltage level V_{R2} received by the data line D₆ can be also transmitted to the data line D₄. As a result, the sub-pixel B₂ and the sub-pixel R₂ can be respectively charged to reach the voltage level V_{R2} through the data line D₆ and the data line D₄ during the fourth time interval T₄. After the fourth time interval T₄ is expired, the switch S₄ is disabled. In the following, the data source DS generates the voltage level V_{G2}. The voltage level V_{G2} is transmitted to the data line D₆ through the data source line DSL₁ during a fifth time interval T₅. At the time, the switch S₅ is enabled. Thus, the voltage level V_{G2} received by the data line D₆ can be also transmitted to the data line D₅. As a result, the sub-pixel B₂ and the sub-pixel G₂ can be respectively charged to reach the voltage level V_{G2} through the data line D₆ and the data line D₅ during the fifth time interval T₅. After the fifth time interval T₅ is expired, the switch S₅ is disabled. In the following, the data source DS generates the voltage level V_{B2}. The voltage level V_{B2} is transmitted to the data line D₆ through the data source line DSL₁ during a sixth time interval T₆. As a result, the sub-pixel B₂ can be charged to reach the voltage level V_{B2} through the data line D₆ during the sixth time interval T₆. In the embodiment, the data source DS generates different voltage levels and transmits these voltage levels to the data line D₆ through the data source line DSL₁ during several time intervals. By doing so, the sub-pixel R₁, the sub-pixel G₁, the sub-pixel B₁, the sub-pixel R₂, the sub-pixel G₂, and the sub-pixel B₂ of the pixel block PB₁ can be respectively charged to the corresponding target voltage levels. The aforementioned driving process can be illustrated as the following table.

TABLE A

| | | | | | | Condition of charge | | | | | |
|---|---|---|---|---|---|---|---|---|---|---|---|
| | S₁ | S₂ | S₃ | S₄ | S₅ | R₁ | G₁ | B₁ | R₂ | G₂ | B₂ |
| T₁ | EN | DIS | DIS | DIS | DIS | V_{R1} | | | | | V_{R1} |
| T₂ | DIS | EN | DIS | DIS | DIS | V_{R1} | V_{G1} | | | | V_{G1} |
| T₃ | DIS | DIS | EN | DIS | DIS | V_{R1} | V_{G1} | V_{B1} | | | V_{B1} |
| T₄ | DIS | DIS | DIS | EN | DIS | V_{R1} | V_{G1} | V_{B1} | V_{R2} | | V_{R2} |
| T₅ | DIS | DIS | DIS | DIS | EN | V_{R1} | V_{G1} | V_{B1} | V_{R2} | V_{G2} | V_{G2} |
| T₆ | DIS | DIS | DIS | DIS | DIS | V_{R1} | V_{G1} | V_{B1} | V_{R2} | V_{G2} | V_{B2} |

In table A, the first row represents the switch S₁ to the switch S₅. The first column represents the time interval T₁ to the time interval T₆. The notation “EN” denotes the switch being enabled. The notation “DIS” denotes the switch being disabled. Obviously, six sub-pixels of the pixel block PB₁ can be respectively charged to reach the corresponding target voltage levels in a steady state. Specifically, the number of mischarges of the sub-pixel B₂ of the pixel block PB₁ is equal to 5. Although the mischarge status of the sub-pixel B₂ is occurred in a transient state, it can be ignored since time duration of the transient state is quite smaller than time duration of the steady state. In other words, the driving method of the pixel block PB₁ is that when several voltage levels (i.e., voltage level V_{R1}, voltage level V_{G1}, voltage level V_{B1}, voltage level V_{R2}, voltage level V_{G2}, and voltage level V_{B2}) are sequentially transmitted from the data source DS to the data line D₆ and the data line D₁ to the data line D₅, the switches (i.e., switch S₁, switch S₂, switch S₃, switch S₄, and switch S₅) are enabled and then disabled sequentially. Thus, when a corresponding voltage level is written to the sub-pixel B₂, the corresponding voltage level is written to at least one sub-pixel of the sub-pixel R₁, the sub-pixel G₁, the sub-pixel B₁, the sub-pixel R₂, and the sub-pixel G₂. Additionally, since the sub-pixel B₂ is pre-charged to reach the voltage level V_{G2} through the data line D₆ during the fifth time interval T₅, only (V_{B2}-V_{G2}) voltage is required for charging the sub-pixel B₂ to reach the voltage level V_{B2} during the sixth time interval T₆.

However, the method for driving the row of sub-pixels of the pixel block PB₁ is not limited to the method illustrated in table A. The method can be modified or changed to achieve a status that six sub-pixels of the pixel block PB₁ can be respectively charged to reach the corresponding target voltage levels (i.e., voltage level V_{R1}, voltage level V_{G1}, voltage level V_{B1}, voltage level V_{R2}, voltage level V_{G2}, and voltage level V_{B2}) in a steady state. The operation modes of the switch S₁ to the switch S₅ can also be changed. For example, in another embodiment, the switch S₁ to the switch S₅ can be enabled initially. The method for driving the row of sub-pixels of the pixel block PB₁ can be processed according to the following table.

TABLE B

| | | | | | | Condition of charge | | | | | |
|---|---|---|---|---|---|---|---|---|---|---|---|
| | S₁ | S₂ | S₃ | S₄ | S₅ | R₁ | G₁ | B₁ | R₂ | G₂ | B₂ |
| T₁ | EN | EN | EN | EN | EN | V_{R1} | V_{R1} | V_{R1} | V_{R1} | V_{R1} | V_{R1} |
| T₂ | DIS | EN | EN | EN | EN | V_{R1} | V_{G1} | V_{G1} | V_{G1} | V_{G1} | V_{G1} |
| T₃ | DIS | DIS | EN | EN | EN | V_{R1} | V_{G1} | V_{B1} | V_{B1} | V_{B1} | V_{B1} |
| T₄ | DIS | DIS | DIS | EN | EN | V_{R1} | V_{G1} | V_{B1} | V_{R2} | V_{R2} | V_{R2} |
| T₅ | DIS | DIS | DIS | DIS | EN | V_{R1} | V_{G1} | V_{B1} | V_{R2} | V_{G2} | V_{G2} |
| T₆ | DIS | DIS | DIS | DIS | DIS | V_{R1} | V_{G1} | V_{B1} | V_{R2} | V_{G2} | V_{B2} |

In table B, the switches (i.e., switch S₁, switch S₂, switch S₃, switch S₄, and switch S₅) are disabled sequentially. However, although six sub-pixels of the pixel block PB₁ can be respectively charged to reach the corresponding target voltage levels (i.e., voltage level V_{R1}, voltage level V_{G1}, voltage level V_{B1}, voltage level V_{R2}, voltage level V_{G2}, and voltage level V_{B2}) in a steady state, mischarge statuses of the sub-pixel G₁ to the sub-pixel B₂ are occurred in the transient state. Specifically, the number of mischarges of the sub-pixel G₁ is equal to one. The number of mischarges of the sub-pixel B₁ is equal to two. The number of mischarges of the sub-pixel R₂ is equal to three. The number of mischarges of the sub-pixel G₂ is equal to four. The number of mischarges of the sub-pixel B₂ is equal to five. Equivalently, the number of mischarges of all sub-pixels is equal to 15. The number of mischarges of all sub-pixels in table B is greater than the number of mischarges of all sub-pixels in table A. Thus, the method for driving the row of sub-pixels of the pixel block PB₁ by using the switches which are enabled and then disabled sequentially outperforms the method for driving the row of sub-pixels of the pixel block PB₁ by using the switches which are disabled sequentially.

The driving method of the pixel block PB₂ of the display panel 100 is similar to the driving method of the pixel block PB₁ of the display panel 100. For the pixel block PB₁, the driving currents are transmitted from the data source line DSL₁ to the corresponding sub-pixels through the data line D₁ to D₆ so that the corresponding sub-pixels can be charged to reach the target voltage levels respectively. For the pixel block PB₂ in FIG. 4, the driving currents generated from the data source DS are transmitted to the data line D₁₂ through the data source line DSL₂ for charging a sub-pixel B₄ to reach a target voltage level. Similarly, the switches S₆ to S₁₀ can be enabled and then disabled sequentially, or can be selectively disabled sequentially. By doing so, a target voltage level can be inputted to a corresponding sub-pixel (i.e., a corresponding sub-pixel selected from the sub-pixel R₃ to the sub-pixel G₄) through a corresponding switch. Since the driving method of the pixel block PB₂ is similar to the driving method of the pixel block PB₁, the illustration is omitted here. Particularly, in the pixel block PB₂, since the data line D₁₂ can be regarded as an embedded connection line for transmitting data signal from the data source DS to the pixel block PB₂, a quantity of connection lines in the fan-out circuit can be reduced, leading to optimize the allocation of the data circuit DC and the fan-out circuit. Further, since a structure of each pixel block of the rest pixel blocks in the display panel 100 is similar to the structure of the pixel block PB₁ or PB₂ shown in FIG. 4, the layout area requirement of the display panel 100 can be further reduced, leading to optimize the border width of the display panel 100.

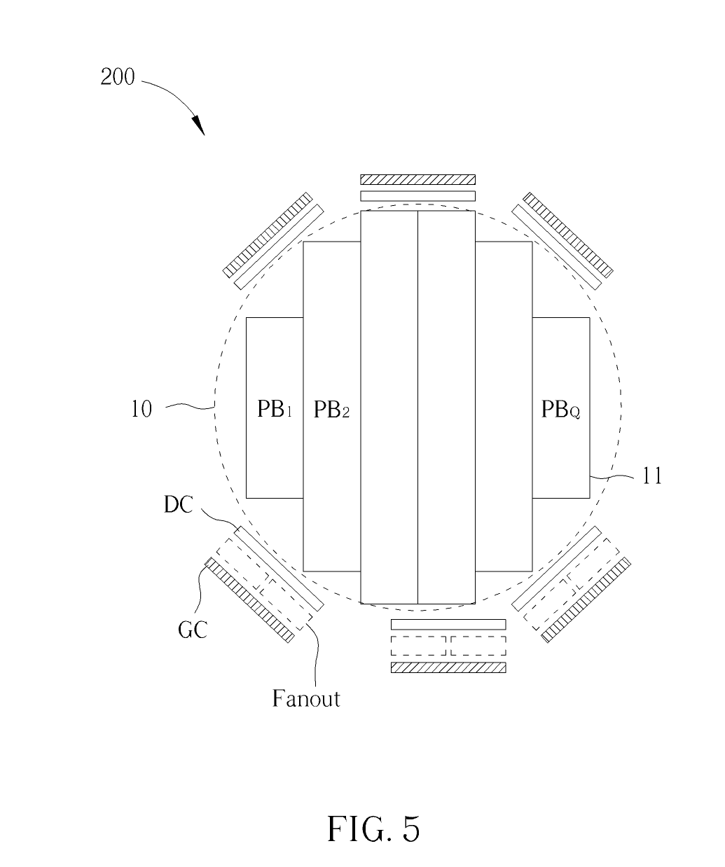

FIG. 5 illustrates a structure of a display panel 200 according to a second embodiment of the present invention. As shown in FIG. 5, pair-wised gate circuit GC and data circuit DC are disposed to a side of two pixel blocks of the display panel 200. Another pair-wised gate circuit GC and data circuit DC is disposed to another side of the two pixel blocks of the display panel 200. Specifically, a fan-out circuit can be disposed between the gate circuit GC and the data circuit DC. In the display panel 200, the data circuit DC disposed to the downside of the pixel block PB₁ and the pixel block PB₂ can be used for driving the pixel block PB₁. The data circuit DC disposed to the upside of the pixel block PB₁ and the pixel block PB₂ can be used for driving the pixel block PB₂. As a result, a thickness of the data circuit DC can be further reduced. For example, in the display panel 100, a width of the data circuit DC is smaller than or equal to a width of the pixel block. In the display panel 200, a width of the data circuit is 1-2 times greater than a width of the pixel block. However, a thickness of the data circuit DC of the display panel 200 is quite smaller (i.e., around ⅕) than a thickness of the data circuit DC of the display panel 100. Thus, a layout area requirement of the data circuit DC of the display panel 200 is smaller than a layout area requirement of the data circuit DC of the display panel 100. Thus, a width of border of the display panel 200 can be further reduced.

Although the display panel 100 and display panel 200 are circular display panels, the present invention is not limited to the circular display panels. For example, in other embodiments, the display panel can be a rectangular shaped display panel, a triangular shaped display panel, or any arc shaped display panel. The display panel 100 and 200 uses the demultiplexer with 6 dimensions. However, the present invention is not limited to use the demultiplexer with 6 dimensions. In other embodiments, any demultiplexer with at least 2 dimensions can be applied to the display panel. Further, the row of sub-pixels of the display panel 100 and 200 are allocated sequentially according to a pixel sequence formed by a red sub-pixel, a green sub-pixel, and a blue sub-pixel. However, the row of sub-pixels of the present invention is not limited to use the fixed pixel sequence. In other embodiments, each pixel block can include a subset of three primary color sub-pixels. For example, a first pixel block can include a red sub-pixel R and a green sub-pixel G. A second pixel block can include a blue sub-pixel B and a red sub-pixel R. A third pixel block can include a green sub-pixel G and a blue sub-pixel B.

To sum up, the present invention discloses a display panel with a slim border. Some data lines of pixel blocks can be regarded as some embedded connection lines for transmitting data signal. The method for driving display panel is also disclosed. The idea is to charge at least two sub-pixels to reach a voltage level generated by a data source simultaneously. Since a quantity of connection lines in the fan-out circuit can be reduced, allocations of the data circuit DC and the fan-out circuit can be optimized. Thus, a width or layout area requirement of the display panel border can be further reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display panel, comprising:
a pixel block, comprising:
a first sub-pixel coupled to a first data line; and
N second sub-pixels, each second sub-pixel of the N second sub-pixels coupled to a corresponding second data line of N second data lines;
a data circuit, comprising:
N switches, each switch of the N switches coupled to a corresponding second sub-pixel; and
a data source coupled to the first data line and the N second data lines;
wherein when N voltage levels are sequentially outputted from the data source to the first data line and the N second data lines, the N switches are disabled sequentially so that when a corresponding voltage level is written to the first sub-pixel, the corresponding voltage level is written to at least one second sub-pixel of the N second sub-pixels, and N is a positive integer.

2. The display panel of claim 1, wherein when the N voltage levels are sequentially outputted from the data source to the first data line and the N second data lines, the N switches are enabled and then disabled sequentially.

3. The display panel of claim 1, wherein two data circuits respectively coupled to two adjoining pixel blocks are disposed to different sides of the two adjoining pixel blocks.

4. The display panel of claim 1, wherein the N second sub-pixels and the first sub-pixel are allocated sequentially according to a pixel sequence formed by a red sub-pixel, a green sub-pixel, and a blue sub-pixel.

5. The display panel of claim 1, further comprising:
a gate circuit configured to drive a plurality of sub-pixels of at least one pixel block;
wherein the gate circuit and the data circuit are disposed to two opposite sides of the pixel block.

6. The display panel of claim 1, wherein widths of a plurality of pixel blocks of the display panel are identical.

7. The display panel of claim 1, wherein a width of the data circuit is smaller than or equal to a width of the pixel block.

8. The display panel of claim 1, wherein a width of the data circuit is 1-2 times greater than a width of the pixel block.

9. The display panel of claim 1, wherein widths of a plurality of pixel blocks of the display panel are not all the same.

10. The display panel of claim 1, wherein the data circuit is a demultiplexer.
